(19) United States
(12) Patent Application Publication
(10) Pub. No.: US 2011/0082708 A1
(43) Pub. Date: Apr. 7, 2011

(54) PORTABLE CONSUMER TRANSACTION PAYMENT DEVICE BEARING SAMPLE PRESCRIPTION

(76) Inventor: Stacy Pourfallah, Oakland, CA (US)

(21) Appl. No.: 12/573,833

(22) Filed: Oct. 5, 2009

(51) Int. Cl. G06Q 50/00; G06Q 30/00; G06F 17/00; G06K 19/07

(52) U.S. Cl. 705/3; 235/380; 235/492

(57) ABSTRACT

In response to a request sent over a network, information is received about a prescription medical supply sample that includes an advertising account for a dispensing pharmacist to chart the cost of the prescription medical supply sample to and an identifier, quantity, and dosage of the prescription medical supply sample. The received information is then written to the memory of a portable consumer transaction payment device along with an identifier for the patient and identifier for the prescribing medical practitioner. The portable consumer transaction payment device is associated with a patient account to engage in transactions on the patient account with merchants in a payment processing network.

### CROSS-REFERENCE TO RELATED APPLICATIONS

The case is filed concurrently with U.S. patent application Ser. No. ______, by Stacy Pourfallah, titled “Portable Prescription Transaction Payment Device,” Attorney Docket No. P-14680US (930676.00326), with U.S. patent application Ser. No. ______, by Stacy Pourfallah, titled “Portable Consumer Transaction Payment Device Bearing Sponsored Free Sample,” Attorney Docket No. P-14680US1 (930676.00411), with U.S. patent application Ser. No. ______, by Stacy Pourfallah, titled “Free Sample Account Transaction Payment Card Kiosk,” Attorney Docket No. P-14680US3 (930676.00413), and with U.S. patent application Ser. No. ______, by Stacy Pourfallah, titled “Prescription Sample Transaction Payment Card,” Attorney Docket No. P-14680US4 (930676.00414), each of which is incorporated herein by reference.

### FIELD

The present invention relates generally to the distribution of samples, and more particularly with the distribution of pharmaceutical samples, and most particularly to a distribution of a prescribed medical supply sample in a transaction with a patient's portable consumer transaction payment device used at a pharmacy to dispense to the patient the prescribed medical supply sample, the portable consumer transaction payment device being associated with the account of a third party who is financially response for the cost of the prescribed medical supply sample.

### BACKGROUND

When a patient sees a healthcare provider for an ailment, often the patient is provided with samples of pharmaceutical products to try. This may be done, for instance, when the healthcare provider is unsure which medication will alleviate the patient's symptoms or illness, or when a prescription is very expensive. However, this form of distribution can be dangerous. The healthcare provider may accidentally provide the wrong sample to the patient, might not keep accurate records of what samples were given, or may not be aware of possible interactions with medications the patient has been prescribed by other providers.

Additionally, the distribution of sample pharmaceutical products by healthcare providers is costly. Pharmaceutical companies must send the sample drugs to representatives, who are then paid to distribute the samples to local healthcare providers. These samples must be individually packaged, often with expensive safety features and elaborate advertisements. Further, the pharmaceutical companies must cover the cost of the samples themselves regardless of whether the healthcare provider ever actually distributes the samples. All of this adds to the soaring prices of medications.

Thus, there is a need for healthcare providers to provide patients with access to sample medications within a more controlled environment, such as a pharmacy. Further, there is a need to reduce medication costs by removing the expense of representatives and individual sample packaging.

### SUMMARY

In one implementation, a method includes receiving, in response to a request sent over a network, information about a prescription medical supply sample that includes an advertising account to which a dispensing pharmacist is to charge the cost of the prescription medical supply sample, and an identifier, quantity, and dosage of the prescription medical supply sample. The received information is then written to the memory of a portable consumer transaction payment device along with an identifier for the patient and identifier for the prescribing medical practitioner. The portable consumer transaction payment device is associated with a patient account to engage in transactions on the patient account with merchants in a payment processing network.

In another implementation, a method includes receiving a transmission from a network in response to a request, where the transmission has information about a prescription medical supply sample that includes an advertising account for the dispensing pharmacist to charge the cost of the prescription medical supply sample to and an identifier, quantity and dosage of the prescription medical supply sample. The method further includes writing to the memory of a portable consumer health services payment device the information received, an identifier for the patient, an identifier for a medical practitioner prescribing the prescription medical supply sample to the patient, and an identifier, quantity, and dosage of a prescription medical supply, other than the prescription medical supply sample, being prescribed by the prescribing medical practitioner to the patient. The patient account is regulated for limited use for payments to healthcare providers and is for the dispensing pharmacists to charge the cost of the prescription medical supply.

In yet another implementation, an apparatus is presented having a user interface to receive a request for a prescription medical supply sample, a network communication device, and a card writer to encode the prescription data in the memory of a portable consumer transaction payment device. The network communication device further is capable of sending the request for a prescription medical supply sample and receiving an advertising account for a dispensing pharmacist to charge the cost of the prescription medical supply sample to. The prescription data includes the advertising account, and identifier for a patient, and an identifier for a prescribing medical practitioner. The prescription data further includes an identifier, a quantity, and a dosage of the prescription medical supply sample and a prescription medical supply, other than the prescription medical supply sample, which the prescribing medical practitioner is prescribing to the patient. The prescription data also includes an image of a prescription for the patient from the prescribing medical practitioner. Included in the memory of the portable consumer transaction payment device is a consumer account for a consumer to engage in transactions on the consumer account with merchants in a payment processing network, where the dispensing pharmacist is one such merchant in the payment processing network and the charging of the cost of the prescription medical supply sample to the advertising account for the payment to the dispensing pharmacist account is another said transaction in the payment processing network. Each transaction in the payment processing network is submitted by the merchant to an acquirer for processing by a transaction handler who requests an issuer of a corresponding account upon which the transaction was conducted to obtain payment for the transaction from the corresponding account, and wherein the issuer of the corresponding account forwards the payment for the transaction to the transaction handler who forwards the payment for the transaction to the acquirer to reimburse the merchant for the transaction.

The foregoing advantages will appear in the detailed description that follows. In the description, reference is made to the accompanying drawings.

### BRIEF DESCRIPTION OF THE DRAWINGS

Implementations of the invention will become more apparent from the detailed description set forth below when taken in conjunction with the drawings, in which like elements bear like reference numerals.

FIG. 1 depicts a block diagram of an exemplary method of a healthcare provider using a card processor system to associate a portable consumer transaction payment device with an electronic voucher;

FIG. 2 illustrates possible alternative implementations of the data encoding area of a portable consumer transaction payment device capable of being associated with an electronic voucher for a sample;

FIG. 3 depicts the environment within FIG. 5 where a portable consumer transaction payment device is used by a patient to obtain a sample;

FIG. 4 depicts a flow chart of an exemplary method used by a transaction handler to process an electronic voucher stored on a portable consumer transaction payment device; and

FIG. 5 illustrates an exemplary payment processing network, depicting the general environment where a portable consumer transaction payment device may be used by a card holder to obtain a sample.

### DETAILED DESCRIPTION

The present discussion considers the distribution a distribution of a sample of a prescription medical supply to a patient in a transaction with a dispensing pharmacist by use of the patient's portable consumer transaction payment device. In the present context, an account for the payment of a sample attributable to an electronic voucher is issued by an issuer to a third-party sponsor of the electronic voucher and credited with funds submitted by the third-party. The funds on deposit in the account are for reimbursement of a distribution of the sample to the patient by a dispensing pharmacist upon the presentation of the patient's portable consumer transaction payment device having the electronic voucher stored thereon.

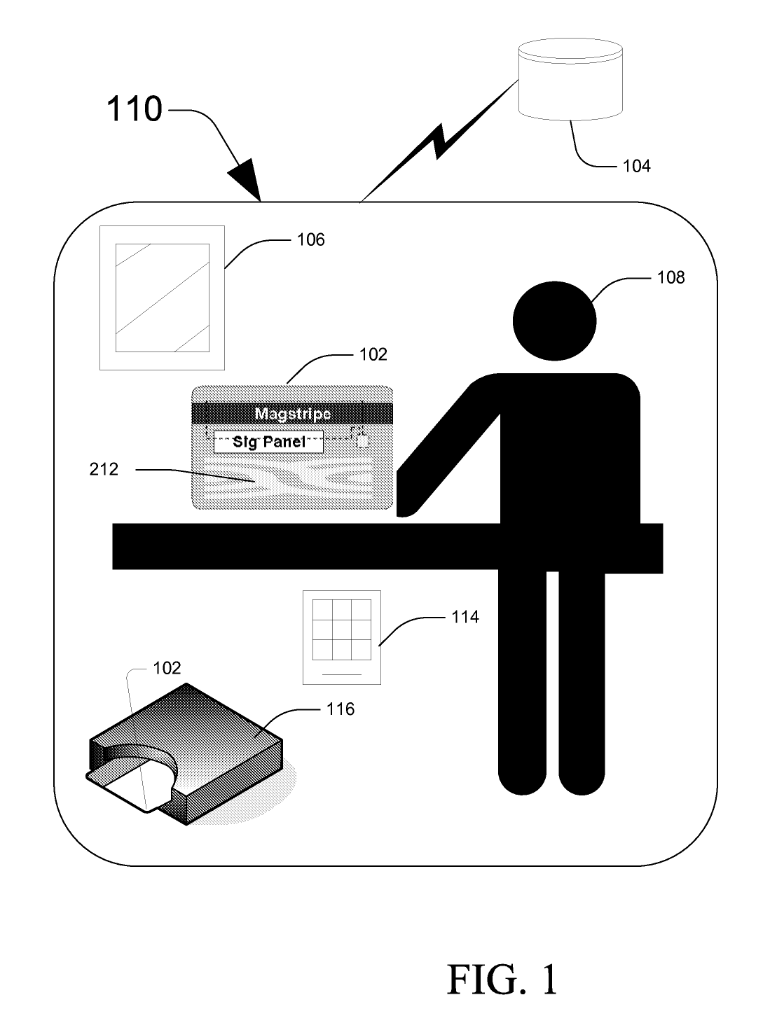

Turning now to FIG. 1, an exemplary block diagram is presented of an environment 110 of a healthcare provider using a card processor system to associate a portable consumer transaction payment device with an electronic voucher, where the portable consumer transaction payment device may be used by the patient to obtain a sample from a merchant. Although the implementation is discussed in regards to a substantially planar laminated card, one skilled in the art will recognize that other forms of transaction payment tokens could be used.

Although the present application is primarily concerned with prescription medication, one of ordinary skill in the art will understand that the samples may be of prescription medical supplies, such as by way of example and not limitation, syringes or home medical supplies covered by health insurance. Furthermore, the samples may be of over-the-counter (OTC) medications or medical supplies, such as by way of example and not limitation, aspirin, antiseptics, bandages, creams, or salves.

Further, one of ordinary skill in the art will realize that, in the present discussion, “healthcare provider” is intended to include doctors, nurse practitioners, veterinarians, dentists, psychiatrists, veterinarians, and any other prescriber. Additionally, wherein the sample is for an OTC medication or medical supply, “healthcare provider” may include chiropractors, homeopathic therapists, acupuncturists, physical therapists, or any other provider of health-related services. Also, it will be understood that a patient of a healthcare provider could act through an agent to perform acts described herein.

In certain implementations, a card processor system is connected to a database 104. In certain implementations, database 104 is a database of electronic vouchers for free samples which healthcare provider 108 may distribute to consumers. In one implementation, a third-party offering, and willing to pay for, the distribution of at least one sample using an electronic voucher has access to the database and may send to and receive from the database information such as the number of electronic vouchers used, the number of electronic vouchers remaining, alternatives to a given sample, medications commonly prescribed with a given sample and the availability of such medications, or any other relevant information.

In certain implementations, database 104 is connected to a network accessible by a computer used by healthcare provider 108. In such implementations, the network may be a Local Area Network (LAN), Wide Area Network (WAN), Personal Area Network (PAN), Virtual Private Network (VPN), Storage Area Network (WAN), Global Area Network (GAN), Internetwork, or combination thereof. In such implementations, the computer may connect to the network using wireless communications, optical fiber, Ethernet, ITU-T G.hn, or similar technology, or a combination thereof. In such implementations, the computer may include a network card, network adapter, or network interface controller (NIC). In other implementations, the computer may include other types of hardware capable of connecting to and communicating with a network.

In certain implementations, database 104 is provided by a web service in communication with a website. In such implementations, healthcare provider 108 browses, using a web browser of a web-enabled computer, to the website to select an electronic voucher from database 104.

In certain implementations, database 104 also includes information relating to each electronic voucher stored therein. In such implementations, database 104 may include an identifier for the free sample and an account identifier of the third-party sponsor of the electronic voucher. In certain implementations, the account of the third-party sponsor is a regulated account that's use is limited to payments to healthcare providers. In certain implementations, the third-party account is a revolving credit account, a debit account, or a prepaid account. In certain implementations, the third-party account is a Flexible Savings Account (FSA), a Health Savings Account (HAS), or a Health Reimbursement Account (HRA).

In certain implementations, database 104 includes information also regarding a merchant. In such an implementation, the electronic voucher may only be valid for use with a particular compounding pharmacy or drug store. In other implementations, the information includes the prescription date or an expiration date, after which the electronic voucher is no longer valid. In yet other implementations, the information includes the number of samples eligible for distribution using the electronic voucher. By way of example and not limitation, the electronic voucher may be valid for three (3) sample-sized tubes of a prescription topical cream. In other implementations, the database 104 includes information regarding an expiration date, after which the electronic voucher is no longer valid.

In certain implementations, database 104 includes advertisements capable of being printed by a merchant Point Of Service terminal (POS), (i.e., a cash register) when the sample card bearing the electronic voucher is presented to a pharmacist. In certain implementations, a specific advertisement is selected by healthcare provider 108 to be associated with the sample card. In certain implementations, the advertisements are pre-associated with the electronic vouchers. In certain implementations, the advertisement may be an image. In certain implementations, the advertisement may be for a type of good or service, which may or may not be related to the free prescription sample. In certain implementations, the advertisement may be for the pharmacist providing the free sample or for the third-party sponsor. In certain implementations, the advertisement is of a different good or service provided by healthcare provider 108, the pharmacist, or by the third-party sponsor. In certain implementations, the advertisement is for a merchant, or a good or service provided by a merchant, whose retail location is near healthcare provider 108 or the pharmacist.

In some implementations, database 104 includes information regarding a coupon for a free or discounted item. The coupon may be issued by the sponsor of the electronic voucher. In other implementations, healthcare provider 108 may select a coupon from multiple coupons available in database 104. In yet other implementations, database 104 may automatically associate a coupon with portable consumer transaction payment device 102. The association may be based upon the medications being prescribed, the diagnosis of the patient, or any other criteria. The coupon may be for discounts on prescription medication or over-the-counter items, such as, for example, cough syrups, bandages, or herbal teas. In one implementation the coupon expires with the use of the portable consumer transaction payment device to obtain the sample associated with the electronic voucher, the discount only being redeemable at the time medication is dispensed. In other implementations, the coupon may be redeemable at a later time.

In certain implementations, the identifier of the free sample corresponds to a type of good or service. In certain implementations, the identifier is an image capable of being displayed or printed by a merchant POS. In certain implementations, the identifier of the free sample is a Stock Keeping Unit (SKU). In certain implementations, the identifier of the free sample is a Universal Product Code (UPC). In certain implementations, the identifier is of a trademark associated with the product being distributed as a sample, the trade name of the wholesaler of the product, or the trade name of the manufacturer of the product. In certain implementations, the identifier is for an active ingredient of the product being distributed as a free sample.

The card processor system, in some implementations, may include a user interface 106 capable of presenting healthcare provider 108 with a selection of electronic vouchers available for distribution. The user interface 106 may be a touch screen, a digital electronic display, a projector, a monitor, any combination of the foregoing, or any other device for the presentation of information.

Healthcare provider 108 may select an electronic voucher using input device 114. Input device 114 may be a key pad, a touch screen, a pointing device, an audio input device, a video input device, any combination of the foregoing, or other hardware capable of receiving and transforming data for use by the device.

Card read-write device 116 may then be used to associate the selected electronic vouchers with portable consumer transaction payment device 102 provided by the patient, wherein portable consumer transaction payment device 102 can be used to conduct a transaction for goods or services with various merchants. By way of example and not limitation, portable consumer transaction payment device 102 may be a credit card, debit card, prepaid card, loyalty card or other such device associated with an account of the patient (or agent thereof). Further, portable consumer transaction payment device 102 may be a Health Savings Account (HAS) card or a Flexible Spending Account (FSA) card. In certain implementations, the account of the consumer associated with portable consumer transaction payment device 102 is a regulated account that's use is limited to payments to healthcare providers.

Card read-write device 116 stores information relating to the electronic voucher selected by healthcare provider 108 on portable consumer transaction payment device 102, including the account identifier associated with an account of the third-party sponsor of the electronic voucher.

In certain implementations, the electronic voucher may be for a sample made by a particular manufacturer. In such an implementation, the information may further include an identifier for the manufacturer. In certain implementations, the electronic voucher may be for a particular type of sample made by any manufacturer. In such an implementation, the information may further include an identifier for an acceptable generic alternative to the name-brand sample.

In certain implementations, the electronic voucher may be for a sample of an OTC medication or medical supply, such as, by way of example and not limitation, aspirin, bandages, salves, or creams. In such an implementation, the information may further include a type of sample, or category thereof, for which the portable consumer transaction payment device is valid. By way of example and not limitation, the electronic voucher may be valid for a sample of all OTC pain relievers made by a particular manufacturer. Alternatively, the electronic voucher may be valid for a specific OTC pain reliever made by the manufacturer.

In certain implementations, the information also includes a prescription for a prescription medication. In such implementations, an image may be stored on portable consumer transaction payment device 102 which includes the signature of healthcare provider 108. In certain implementations, the image may contain other information required in specific jurisdictions for a pharmacist to dispense a prescription medical supply. Such information, by way of example and not limitation, may include the an image of the written prescription in the handwriting of the prescribing healthcare provider, the name of the patient, dosing instructions, and/or the refill amount.

In such an implementation where a prescription is included, the electronic voucher may be for a sample of a medication not usually stocked at the pharmacy in sufficient amounts to completely fulfill a prescription. In other such implementations, the electronic voucher may be for a sample of a name-brand medication while the prescription may be for the generic equivalent.

In certain implementations, card read-write device 116 stores additional information on portable consumer transaction payment device 102. Wherein the electronic voucher is for a sample of a prescription medication, card read-write device 116 may additionally store, by way of example and not limitation, identifiers for the prescribing healthcare provider 108, the patient, and the prescription medication for which a sample is to be provided.

In certain implementations, card read-write device 116 is a memory card reader-writer. In such an implementation, portable consumer transaction payment device 102 is a smart card and the account identifier and any additional information is stored in the memory of an embedded chip. In certain implementations, portable consumer transaction payment device 102 is a contact smart card having a contact area that when inserted into card read-write device 116 makes contact with electrical connectors capable of writing the information to memory. In certain implementations, portable consumer transaction payment device 102 is a contactless smart card in which the chip communicates with card read-write device 116 through radio-frequency identification (RFID) induction technology.

In certain implementations, card read-write device 116 is a magnetic card reader. In such an implementation, portable consumer transaction payment device 102 has a magnetic data stripe. The account identifier and any additional information is stored on portable consumer transaction payment device 102 when the magnetic data stripe is placed in physical contact with a read-write head of card read-write device 116. In certain implementations, portable consumer transaction payment device 102 includes both an embedded chip and a magnetic stripe.

In one implementation, portable consumer transaction payment device 102 may also include an image 112 printed on a surface. Image 112 may be preprinted on portable consumer transaction payment device 102 and may serve as an advertisement. Alternatively, image 112 may be printed by the card processor and may relate to the medication prescribed by healthcare provider 108. Further, portable consumer transaction payment device 102 may display a flat or raised account number as well as the prescription name, quantity, instructions, patient name, prescribing healthcare provider's name, and any other relevant information.

Wherein the card processor system is capable of printing image 112 on portable consumer transaction payment device 102, the device may include a card printer such as, for example, the Direct-to-Card (DTC) 450 or High Definition Printing (HDP) 5000 commercially available from Fargo Electronics, Inc., a corporation located in Eden Prairie, Minn.

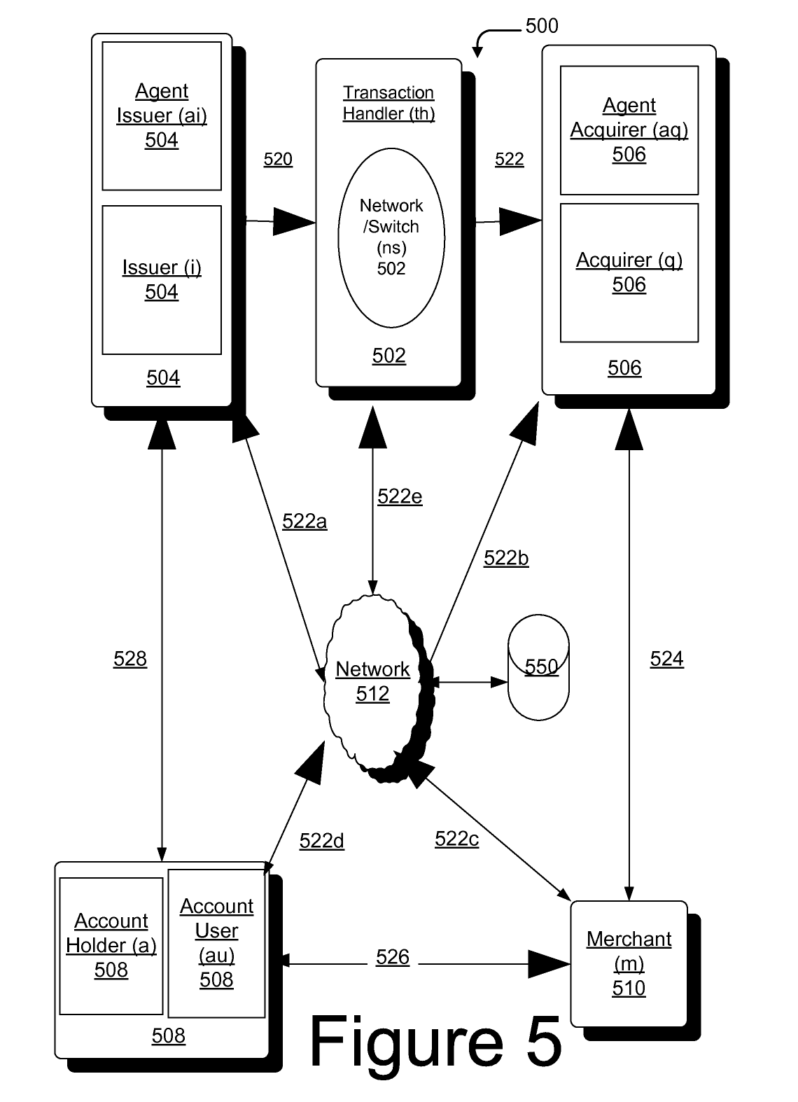

In certain implementations, association of the electronic voucher with portable consumer transaction payment device 102 further involves using the card processor system to provide an identifier of a patient account associated with portable consumer transaction payment device 102 and information regarding the electronic voucher selected by healthcare provider 108 for storage on portable consumer transaction payment device 102 to a transaction handler, such as one or more of transaction handler (th) 502 (FIG. 5), wherein the account identifier and the information is stored in a database. In such an implementation, the database may be used to verify the authenticity of an electronic voucher stored on a portable consumer transaction payment device presented at a merchants location for redemption of a sample.

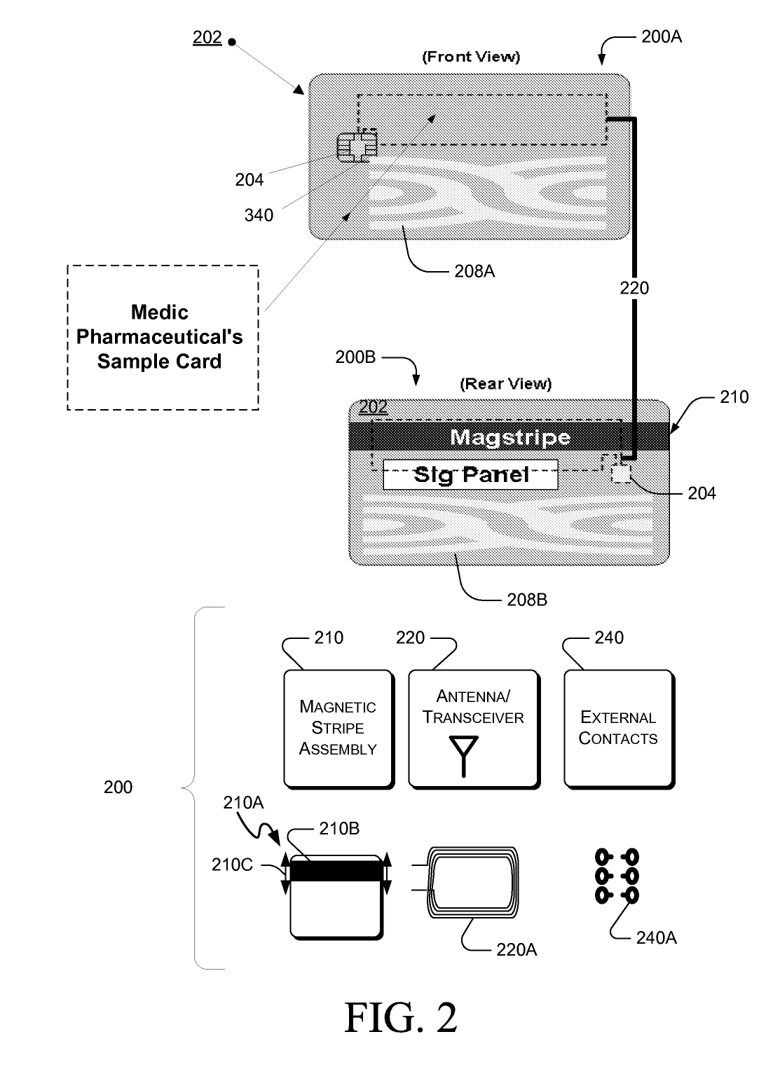

Turning to FIG. 2, both a front view 200A and a rear view 200B of an exemplary portable consumer transaction payment device 202 are presented. Images may be displayed on both sides of portable consumer transaction payment device 202, with image 208A on the front view 200A being either the same as or different from image 208B on the rear view 200B. In this illustration, the front view 200A also displays information about the provider of portable consumer transaction payment device 202.

FIG. 2 also shows exemplary implementations of a data encoding area of portable consumer transaction payment device 202. The data encoding area may include an optional shielding element, which allows desired electromagnetic, optical, or radiative signals to penetrate while protecting the data encoding area from physical abuse or damage. Portable consumer transaction payment device 202 may optionally have areas outside of the data encoding area shielded from physical abuse or otherwise acceptable forms of electromagnetic radiation. Some of the acceptable signals that are allowed to penetrate the shielding may include, but are not limited to, signals accompanying a magnetic field, RFID signals, IrDA signals, visible light, invisible light, modulated laser, and/or modulated RF communication signals. By way of example and not limitation, a selective shielding element may comprise a clear plastic shield, conformal coatings, an opaque plastic shield, or a clear thin film, depending on the implementation of the data encoding area.

Non-limiting examples of the data encoding area are shown at reference numeral 200, and include a magnetic stripe assembly 210, an antenna and/or transceiver 220, and electrical contacts 240. Magnetic stripe assembly 210 may comprise, in the implementation shown as 210A, a reprogrammable magnetic stripe assembly 210B that accepts data and/or commands from a processor and formats and renders that data into a form on a magnetic stripe that is readable by conventional merchant magnetic stripe-reading point of sale (POS) terminals. In this manner, the processor may program a particular account for use in a transaction as a function of user input selecting the account. Alternatively, the processor may erase the magnetic stripe of assembly 210, rendering the card useless in the event of its loss or theft. In the implementation shown as 210A, magnetic stripe assembly 210B at least partially slidably moves 210C into and out of an assembly of portable consumer transaction payment device 202 (partial view shown), allowing portable consumer transaction payment device 202 to conduct a transaction at a point of sale terminal that includes a magnetic stripe reader.

Continuing with FIG. 2, another implementation of the data encoding area is shown as an antenna and/or transceiver 220. Antenna and/or transceiver 220 may include commonly used loop inductors such as the one shown 220A or in those shown in related ISO standards for RF-readable smart cards. With such an interface, account data may be translated, modulated and transmitted in a manner acceptable by an RF contactless merchant POS terminal, a 802.11 WiFi or WiMax network, or by a cellular or RF communications network. For instance, antenna and/or transceiver 220 may receive a wireless communication from a card read-write device, where the wireless communication carries data for a sponsor's electronic voucher account that is to be written in memory to the data encoding area 200.

Electrical contacts 240 are yet another alternative implementation of the data encoding area shown in FIG. 2. With portable consumer transaction payment device 202 possessing physical contacts such as an array of conductive pads or shapes 240A, portable consumer transaction payment device 202 may be placed in physical contact with a merchant POS terminals, and electrical contacts 240 may establish connectivity between imbedded integrated circuit 204 and the merchant's financial processing system. The processor may relay account-related information to the merchant POS terminal through the contact interface, thereby allowing portable consumer transaction payment device 202 to be utilized with the large number of preexisting merchant POS terminals.

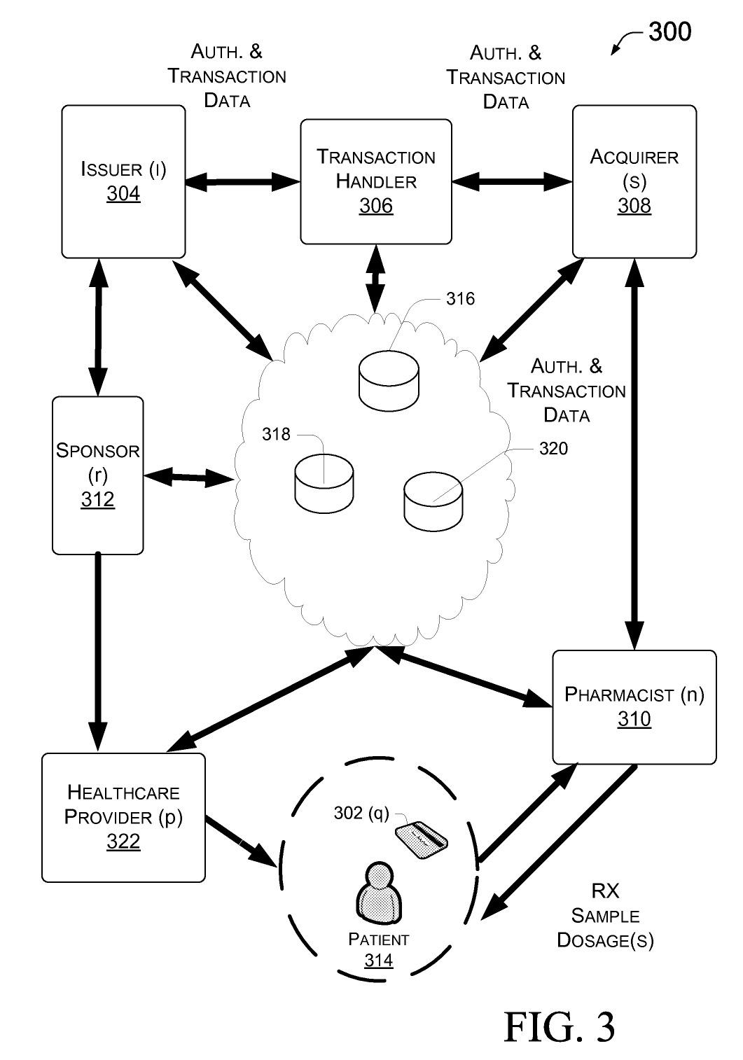

Within the exemplary payment processing system depicted in FIG. 5 and described below, FIG. 3 illustrates the general environment wherein a portable consumer transaction payment device, such as portable consumer transaction payment device 202 (FIG. 2) associated with an electronic voucher by the environment described in connection with FIG. 1, is used by a patient to receive a sample prescription or medical item from a merchant, such as a pharmacy. To start, at the POS terminal of pharmacy 310, patient 314 presents to pharmacy 310 portable consumer transaction payment device 302. In certain implementations, patient 314 additionally presents an item patient 314 wishes to purchase. Pharmacy 310 uses a card reader associated with the POS terminal to read the information stored on portable consumer transaction payment device 302, including the account identifier associated with the one or more electronic vouchers being sponsored, respectively, by one or more sponsors 312 (one such sponsor is indicated in FIG. 3 as sponsor (r) 312). In certain implementations, portable consumer transaction payment device 302 is read by swiping portable consumer transaction payment device 302 through the POS terminal to read data magnetically encoded in its magnetic stripe. In other implementations, the POS terminal reads portable consumer transaction payment device 302 using a contactless technology, such as RFID, when patient 314 is near the POS terminal. In yet other implementations, to be read, portable consumer transaction payment device 302 is inserted into the POS terminal such that external contacts on portable consumer transaction payment device 302 establish connectivity with the POS terminal.

In certain implementations, other information is also read from portable consumer transaction payment device 302, such as, by way of example and not limitation, an expiration date, an sample type, or patient 314's name. In such implementations, the POS terminal may determine whether the electronic voucher is valid for the sample requested. This may occur, by way of example and not limitation, by comparing the current date with the expiration data of the electronic voucher.

In certain implementations, the POS terminal may be connected to a database storing information regarding prescriptions patient 314 has had filled at pharmacy 310 or any related pharmacy 310(n). In such an implementation, the database may be used to determine whether patient 314 is taking any other medication that may interact with the sample to be distributed. Where the sample is of a controlled substance included on a schedule, such a database may additionally be used to force compliance with regulations promulgated by the United States Drug Enforcement Agency. In such implementations, the database may be used to verify that use of the electronic voucher would not allow patient 314 to receive more then the legally allowed limit. By way of example and not limitation, where the sample is for a medication listed on Schedule II, such as Methadone, Oxycodone, or Fentanyl, patients are limited to a thirty (30) day supply unless they meet a legal exception. Thus, the database may be used to determine whether distribution of the sample, alone or in combination with other samples or prescriptions, would give patient 314 more than a thirty (30) day supply. Further, the prescription date may be checked against the date on which patient 314 is requesting the sample to ensure that the sample is being distributed within the legally allowed time frame from the prescription date. Alternatively, wherein the medication is restricted by the number of refills which may be distributed within a given time frame, such as medications on Schedule III and Schedule IV, the data base may be used to determine whether distribution of the sample may be considered a “refill” exceeding the allowed amount under law during that timeframe.

In certain implementations, patient 314 is requested to present identification. In such an implementation, the identification may be checked against a patient identifier read from portable consumer transaction payment device 302 in order to verify that patient 314 was the same patient who was given portable consumer transaction payment device 302 from healthcare provider 322. Alternatively, the identification may be used to verify that the individual presenting portable consumer transaction payment device 302 is authorized to receive medication on behalf of patient 314, such as in the case of a parent or spouse of patient 314.

Upon receipt of portable consumer transaction payment device 302, the transaction is processed similarly to the method to be described in connection with FIG. 5. Pharmacy 310 submits an authorization request to acquirer 308, which includes an account identifier associated with the electronic voucher stored on portable consumer transaction payment device 302. In certain implementations, an account identifier associated with patient 314 is also included in the authorization request.

In certain implementations, the authorization request is for only some of the samples or amounts described by the electronic voucher associated with portable consumer transaction payment device 302. In such an implementation, pharmacy 310 can send the authorization request only for the types of medications or the amount of medication the pharmacy is capable of distributing at that time. In such a situation, patient 314 could then use portable consumer transaction payment device 302 at another pharmacy to receive the rest of the sample associated with the electronic voucher stored on the card. In such cases, memory of device 302 will be accordingly updated to reflect the progressive partial and complete filling of a prescription dispensed by each respective pharmacist (n) 310 to patient 314.

Where acquirer 308 is not the same entity as the issuer of the account associated with the electronic voucher read from portable consumer transaction payment device 302, acquirer 308 forwards the transaction information pertaining to the sample to a transaction handler 306, who in turn forwards it to issuer 304 to verify that the account associated with electronic voucher sponsor 312 contains sufficient funds to reimburse pharmacy 310 for the sample.

Upon receipt of a reply from issuer 304, transaction handler 306 forwards an authorization response regarding the sample to acquirer 308, who forwards it to pharmacy 310. Where the authorization response contains an approval of the use of the electronic voucher, patient 314 is given the associated sample free of charge.

In certain implementations, the authorization response is only a partial response. In such implementations, the authorization request may have included types of samples or amounts not associated with the account identifier of the electronic voucher stored on portable consumer transaction payment device 302. Alternatively, in such implementations, the authorization request may have included items patient 314 wishes to purchase using a financial account belonging to patient 314 and also associated with portable consumer transaction payment device 302 (e.g., the patient's personal credit card account number).

In certain implementations, pharmacy 310 invalidates or deletes the electronic voucher(s) stored on portable consumer transaction payment device 302 once the sample has been provided to patient 314. In certain implementations, the electronic voucher(s) are invalidated or deleted only after all of the samples described in the sample information have been redeemed by patient 314. In such an implementation, patient 314 may fill only part of the prescription sample at a given time or may receive portions of the samples from different pharmacies.

In certain implementations, approval of the transaction may be more involved. In such implementations, the authorization request includes additional information, by way of example and not limitation, the sample medication to be distributed, the prescribing healthcare provider, and/or the sponsor of the electronic voucher. In one implementation, database 316 may be used to, by way of example and not limitation, to verify the number of samples authorized by electronic voucher sponsor 312 for distribution generally or for distribution by a specific doctor. In other implementations, database 316 may be used to verify the types of prescription medications or OTC healthcare items a healthcare provider may distribute using a portable consumer transaction payment device. The number and type of samples distributed in the transaction may then be reflected against the amount and types the healthcare provider has available to distribute in the future.

In other implementations, database 318 is used. Database 318 may contain information regarding all electronic vouchers issued for distribution of each type of sample medication or healthcare item. By way of example and not limitation, database 318 may be used to verify the authenticity of an electronic voucher stored on portable consumer transaction payment device 302 or that the electronic voucher has only been used once.

In yet another implementation, another database, database 320, contains information regarding electronic vouchers associated with a portable consumer transaction payment device and an identifier for that portable consumer transaction payment device. Approval of the transaction request may, in such an implementation, depend upon verification that portable consumer transaction payment device 302 is associated with the electronic voucher stored thereon.

Once the authorization request is approved and the sample associated with the electronic voucher stored on portable consumer transaction payment device 302 is distributed, pharmacy 310 may submit a payment request to payment processing system 300 for reimbursement from electronic voucher sponsor 312's account for the cost of the sample. Specifically, pharmacy 310 submits a request for payment to acquirer 308. Where acquirer 308 is not the same entity as the issuer of the account associated with the account identifier stored on portable consumer transaction payment device 302, acquirer 308 forwards the request to transaction handler 306. Transaction handler 306 in turn requests payment for the sample from issuer 304, where issuer 304 is the issuer of the account associated with electronic voucher sponsor 312. Issuer 304 debits the account and forwards the payment to transaction handler 306 who forwards the payment to acquirer 308. Finally, acquirer 308 credits the account of pharmacy 310 for the cost of the distributed sample.

As will be understood by a person of ordinary skill in the art, the process described in connection with FIG. 3 is equally applicable to the situation where a patient uses a portable consumer transaction payment device having multiple electronic vouchers stored thereon to receive several different samples. In such a situation, the electronic vouchers may be provided by different electronic voucher sponsors (i.e., sponsor (r) 312, sponsor (r+1) 312, sponsor (r+2) 312, etc.) having accounts issued by different issuers for the purpose of reimbursing each dispensing pharmacist (n) 310 for samples. Further, it will be clear to a person of ordinary skill in the art that a portable consumer transaction payment device may have multiple electronic vouchers stored thereon that are valid at different pharmacies, each pharmacy having a different acquirer.

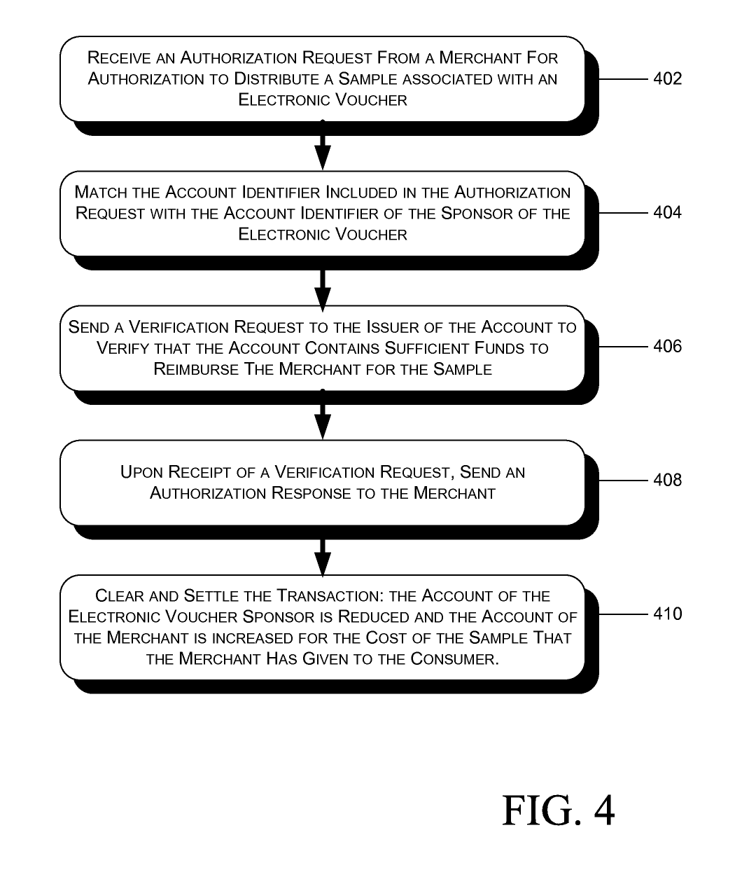

Turning now to FIG. 4, a flow chart is presented of an exemplary method used by a transaction handler to process an electronic voucher for a sample prescription medication stored on a portable consumer transaction payment device. As indicated by block 402, the transaction handler receives an authorization request from a merchant (e.g., via the merchant's acquirer), requesting authorization to distribute a sample associated with an electronic voucher to a patient. Upon receipt of the request, the transaction handler matches the account identifier included in the request with the account identifier associated with the electronic voucher sponsor, as indicated by block 404. In certain implementations, if the account identifier included in the request does not match the account identifier associated with the electronic voucher sponsor, the transaction handler sends an authorization response to the merchant indicating that the transaction is not authorized such that there will be a denial of the distribution of the free sample to the patient. In such an implementation, the process may end.

In the illustrated implementation of FIG. 4, the transaction handler next sends a request to the issuer of the account associated with the electronic voucher sponsor requesting verification that the account contains sufficient funds to reimburse the merchant for the sample, as indicated by block 406. As indicated by block 408, upon receipt of a response from the issuer, the transaction handler sends a response to the merchant (e.g., via the merchant's acquirer). Where the issuer confirms that the account contains sufficient funds, the response to the authorization request may contain an approval of the transaction. Finally, as indicated by block 410, the transaction handler clears and settles the transaction by facilitating a process in which the issuer debits the account of the electronic voucher sponsor and an acquirer for the pharmacist credits the pharmacist's account for the cost of the prescription medical supply sample that the pharmacist compounded and dispensed to the patient.

In certain implementations, individual blocks described above may be combined, eliminated, or reordered.

In certain implementations, instructions are encoded in computer readable medium wherein those instructions are executed by a processor to perform one or more of the blocks 402, 404, 406, 408, and 410 recited in FIG. 4.

In yet other implementations, instructions reside in any other computer program product, where those instructions are executed by a computer external to, or internal to, a computing system to perform one or more of the blocks 402, 404, 406, 408, and 410 recited in FIG. 4. In either case the instructions may be encoded in a computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

An Exemplary Transaction Processing System

Referring to FIG. 5, a transaction processing system 500 is seen. The general environment of FIG. 5 include that of a merchant (m) 510, such as the merchant, who can conduct a transaction for goods and/or services with an account user (au) (e.g., consumer) on an account issued to an account holder (a) 508 by an issuer (i) 504, where the processes of paying and being paid for the transaction are coordinated by at least one transaction handler (th) 502 (e.g., the transaction handler) (collectively “users”). The transaction includes participation from different entities that are each a component of the transaction processing system 500.

The transaction processing system 500 may have at least one of a plurality of transaction handlers (th) 502 that includes transaction handler (1) 502 through transaction handler (TH) 502, where TH can be up to and greater than an eight digit integer.

The transaction processing system 500 has a plurality of merchants (m) 510 that includes merchant (1) 510 through merchant (M) 510, where M can be up to and greater than an eight digit integer. Merchant (m) 510 may be a person or entity that sells goods and/or services. Merchant (m) 510 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder (a) 508 may be a second merchant (m) 510 making a purchase from another merchant (m) 510.

Transaction processing system 500 includes account user (1) 508 through account user (AU) 508, where AU can be as large as a ten digit integer or larger. Each account user (au) conducts a transaction with merchant (m) 510 for goods and/or services using the account that has been issued by an issuer (i) 504 to a corresponding account holder (a) 508. Data from the transaction on the account is collected by the merchant (m) 510 and forwarded to a corresponding acquirer (a) 506. Acquirer (a) 506 forwards the data to transaction handler (th) 502 who facilitates payment for the transaction from the account issued by the issuer (i) 504 to account holder (a) 508.

Transaction processing system 500 has a plurality of acquirers (q) 506. Each acquirer (q) 506 may be assisted in processing one or more transactions by a corresponding agent acquirer (aq) 506, where ‘q’ can be an integer from 1 to Q, where aq can be an integer from 1 to AQ, and where Q and AQ can be as large as a eight digit integer or larger. Each acquirer (q) 506 may be assisted in processing one or more transactions by a corresponding agent acquirer (aq) 506, where ‘q’ can be an integer from 1 to Q, where aq can be an integer from 1 to AQ, and where Q and AQ can be as large as a eight digit integer or larger.

The transaction handler (th) 502 may process a plurality of transactions within the transaction processing system 500. The transaction handler (th) 502 can include one or a plurality or networks and switches (ns) 502. Each network/switch (ns) 502 can be a mainframe computer in a geographic location different than each other network/switch (ns) 502, where ‘ns’ is an integer from one to NS, and where NS can be as large as a four digit integer or larger.

Dedicated communication systems 520, 522 (e.g., private communication network(s)) facilitate communication between the transaction handler (th) 502 and each issuer (i) 504 and each acquirer (a) 506. A Network 512, via e-mail, the World Wide Web, cellular telephony, and/or other optionally public and private communications systems, can facilitate communications 522a -522e among and between each issuer (i) 504, each acquirer (a) 506, each merchant (m) 510, each account holder (a) 508, and the transaction handler (th) 502. Alternatively and optionally, one or more dedicated communication systems 524, 526, and 528 can facilitate respective communications between each acquirer (a) 506 and each merchant (m) 510, each merchant (m) and each account holder (a) 508, and each account holder (a) 508 and each issuer (i) 504, respectively.

The Network 512 may represent any of a variety of suitable means for exchanging data, such as: an Internet, an intranet, an extranet, a wide area network (WAN), a local area network (LAN), a virtual private network, a satellite communications network, an Automatic Teller Machine (ATM) network, an interactive television network, or any combination of the forgoing. Network 512 may contain either or both wired and wireless connections for the transmission of signals including electrical, magnetic, and a combination thereof. Examples of such connections are known in the art and include: radio frequency connections, optical connections, etc. To illustrate, the connection for the transmission of signals may be a telephone link, a Digital Subscriber Line, or cable link. Moreover, network 512 may utilize any of a variety of communication protocols, such as Transmission Control Protocol/Internet Protocol (TCP/IP), for example. There may be multiple nodes within the network 512, each of which may conduct some level of processing on the data transmitted within the transaction processing system 500.

Users of the transaction processing system 500 may interact with one another or receive data about one another within the transaction processing system 500 using any of a variety of communication devices. The communication device may have a processing unit operatively connected to a display and memory such as Random Access Memory (“RAM”) and/or Read-Only Memory (“ROM”). The communication device may be combination of hardware and software that enables an input device such as a keyboard, a mouse, a stylus and touch screen, or the like.

For example, use of the transaction processing system 500 by the account holder (a) 508 may include the use of a portable consumer device (PCD). The PCD may be one of the communication devices, or may be used in conjunction with, or as part of, the communication device. The PCD may be in a form factor that can be: a card (e.g., bank card, payment card, financial card, credit card, charge card, debit card, gift card, transit pass, smart card, access card, a payroll card, security card, healthcare card, or telephone card), a tag, a wristwatch, wrist band, a key ring, a fob (e.g., SPEEDPASS® commercially available from ExxonMobil Corporation), a machine readable medium containing account information, a pager, a cellular telephone, a personal digital assistant, a digital audio player, a computer (e.g., laptop computer), a set-top box, a portable workstation, a minicomputer, or a combination thereof. The PCD may have near field or far field communication capabilities (e.g., satellite communication or communication to cell sites of a cellular network) for telephony or data transfer such as communication with a global positioning system (GPS). The PCD may support a number of services such as SMS for text messaging and Multimedia Messaging Service (MMS) for transfer of photographs and videos, electronic mail (email) access.

The PCD may include a computer readable medium. The computer readable medium, such as a magnetic stripe or a memory of a chip or a chipset, may include a volatile, a non-volatile, a read only, or a programmable memory that stores data, such as an account identifier, a consumer identifier, and/or an expiration date. The computer readable medium may including executable instructions that, when executed by a computer, the computer will perform a method. For example, the computer readable memory may include information such as the account number or an account holder (a) 508's name.

Examples of the PCD with memory and executable instructions include: a smart card, a personal digital assistant, a digital audio player, a cellular telephone, a personal computer, or a combination thereof. To illustrate, the PCD may be a financial card that can be used by a consumer to conduct a contactless transaction with a merchant, where the financial card includes a microprocessor, a programmable memory, and a transponder (e.g., transmitter or receiver). The financial card can have near field communication capabilities, such as by one or more radio frequency communications such as are used in a “Blue Tooth” communication wireless protocol for exchanging data over short distances from fixed and mobile devices, thereby creating personal area networks.

Merchant (m) 510 may utilize at least one POI terminal (e.g., Point of Service or browser enabled consumer cellular telephone); that can communicate with the account user (au) 508, the acquirer (a) 506, the transaction handler (th) 502, or the issuer (i) 504. A Point of Interaction (POI) can be a physical or virtual communication vehicle that provides the opportunity, through any channel to engage with the consumer for the purposes of providing content, messaging or other communication, related directly or indirectly to the facilitation or execution of a transaction between the merchant (m) 510 and the consumer. Examples of the POI include: a physical or virtual Point of Service (POS) terminal, the PCD of the consumer, a portable digital assistant, a cellular telephone, paper mail, e-mail, an Internet website rendered via a browser executing on computing device, or a combination of the forgoing. Thus, the POI terminal is in operative communication with the transaction processing system 500.

The PCD may interface with the POI using a mechanism including any suitable electrical, magnetic, or optical interfacing system such as a contactless system using radio frequency, a magnetic field recognition system, or a contact system such as a magnetic stripe reader. To illustrate, the POI may have a magnetic stripe reader that makes contact with the magnetic stripe of a healthcare card (e.g., Flexible Savings Account card) of the consumer. As such, data encoded in the magnetic stripe on the healthcare card of consumer read and passed to the POI at merchant (m) 510. These data can include an account identifier of a healthcare account. In another example, the POI may be the PCD of the consumer, such as the cellular telephone of the consumer, where the merchant (m) 510, or an agent thereof, receives the account identifier of the consumer via a webpage of an interactive website rendered by a browser executing on a World Wide Web (Web) enabled PCD.

Typically, a transaction begins with account user (au) 508 presenting the portable consumer device to the merchant (m) 510 to initiate an exchange for resources (e.g., a good or service). The portable consumer device may be associated with an account (e.g., a credit account) of account holder (a) 508 that was issued to the account holder (a) 508 by issuer (i) 504.

Merchant (m) 510 may use the POI terminal to obtain account information, such as a number of the account of the account holder (a) 508, from the portable consumer device. The portable consumer device may interface with the POI terminal using a mechanism including any suitable electrical, magnetic, or optical interfacing system such as a contactless system using radio frequency or magnetic field recognition system or contact system such as a magnetic stripe reader. The POI terminal sends a transaction authorization request to the issuer (i) 504 of the account associated with the PCD. Alternatively, or in combination, the PCD may communicate with issuer (i) 504, transaction handler (th) 502, or acquirer (a) 506.

Issuer (i) 504 may authorize the transaction and forward same to the transaction handler (th) 502. Transaction handler (th) 502 may also clear the transaction. Authorization includes issuer (i) 504, or transaction handler (th) 502 on behalf of issuer (i) 504, authorizing the transaction in connection with issuer (i) 504′s instructions such as through the use of business rules. The business rules could include instructions or guidelines from the transaction handler (th) 502, the account holder (a) 508, the merchant (m) 510, the acquirer (a) 506, the issuer (i) 504, a related financial institution, or combinations thereof. The transaction handler (th) 502 may, but need not, maintain a log or history of authorized transactions. Once approved, the merchant (m) 510 may record the authorization, allowing the account user (au) 508 to receive the good or service from merchant (m) or an agent thereof

The merchant (m) 510 may, at discrete periods, such as the end of the day, submit a list of authorized transactions to the acquirer (a) 506 or other transaction related data for processing through the transaction processing system 500. The transaction handler (th) 502 may optionally compare the submitted authorized transaction list with its own log of authorized transactions. The transaction handler (th) 502 may route authorization transaction amount requests from the corresponding the acquirer (a) 506 to the corresponding issuer (i) 504 involved in each transaction. Once the acquirer (a) 506 receives the payment of the authorized transaction from the issuer (i) 504, the acquirer (a) 506 can forward the payment to the merchant (m) 510 less any transaction costs, such as fees for the processing of the transaction. If the transaction involves a debit or pre-paid card, the acquirer (a) 506 may choose not to wait for the issuer (i) 504 to forward the payment prior to paying merchant (m) 510.

There may be intermittent steps in the foregoing process, some of which may occur simultaneously. For example, the acquirer (a) 506 can initiate the clearing and settling process, which can result in payment to the acquirer (a) 506 for the amount of the transaction. The acquirer (a) 506 may request from the transaction handler (th) 502 that the transaction be cleared and settled. Clearing includes the exchange of financial information between the issuer (i) 504 and the acquirer (a) 506 and settlement includes the exchange of funds. The transaction handler (th) 502 can provide services in connection with settlement of the transaction. The settlement of a transaction includes depositing an amount of the transaction settlement from a settlement house, such as a settlement bank, which transaction handler (th) 502 typically chooses, into a clearinghouse bank, such as a clearing bank, that acquirer (a) 506 typically chooses. The issuer (i) 504 deposits the same from a clearinghouse bank, such as a clearing bank, which the issuer (i) 504 typically chooses, into the settlement house. Thus, a typical transaction involves various entities to request, authorize, and fulfill processing the transaction.

The transaction processing system 500 will preferably have network components suitable for scaling the number and data payload size of transactions that can be authorized, cleared and settled in both real time and batch processing. These include hardware, software, data elements, and storage network devices for the same. Examples of transaction processing system 500 include those operated, at least in part, by: American Express Travel Related Services Company, Inc; MasterCard International, Inc.; Discover Financial Services, Inc.; First Data Corporation; Diners Club International, LTD; Visa Inc.; and agents of the foregoing.

Each of the network/switch (ns) 502 can include one or more data centers for processing transactions, where each transaction can include up to 100 kilobytes of data or more. The data corresponding to the transaction can include information about the types and quantities of goods and services in the transaction, information about the account holder (a) 508, the account user (au) 508, the merchant (m) 510, tax and incentive treatment(s) of the goods and services, coupons, rebates, rewards, loyalty, discounts, returns, exchanges, cash-back transactions, etc.

By way of example, network/switch (ns) 502 can include one or more mainframe computers (e.g., one or more IBM mainframe computers) for one or more server farms (e.g., one or more Sun UNIX Super servers), where the mainframe computers and server farms can be in diverse geographic locations.

Each issuer (i) 504 (or agent issuer (ai) 504 thereof) and each acquirer (a) 506 (or agent acquirer (aq) 506 thereof) can use or more router/switch (e.g., Cisco™ routers/switches) to communicate with each network/switch (ns) 502 via dedicated communication systems.

Transaction handler (th) 502 can store information about transactions processed through transaction processing system 500 in data warehouses such as may be incorporated as part of the plurality of networks/switches 502. This information can be data mined. The data mining transaction research and modeling can be used for advertising, account holder and merchant loyalty incentives and rewards, fraud detection and prediction, and to develop tools to demonstrate savings and efficiencies made possible by use of the transaction processing system 500 over paying and being paid by cash, or other traditional payment mechanisms.

The VisaNet® system is an example component of the transaction handler (th) 502 in the transaction processing system 500. Presently, the VisaNet® system is operated in part by Visa Inc. As of 2006, the VisaNet® system Inc. was processing around 300 million transaction daily, on over 1 billion accounts used in over 170 countries. Financial instructions numbering over 16,000 connected through the VisaNet® system to around 20 million merchants (m) 510. In 2007, around 71 billion transactions for about 4 trillion U.S. dollars were cleared and settled through the VisaNet® system, some of which involved a communication length of around 24,000 miles in around two (2) seconds.

The following example is presented to further illustrate to persons skilled in the art how to make and use the invention. This example is not intended as a limitation, however, upon the scope of the invention, which is defined only by the appended claims.

### EXAMPLE

By way of example and not limitation, a doctor may diagnose a patient as needing a medication, manufactured and distributed by a given pharmaceutical company, and decide to provide a sample using a portable consumer transaction payment device according to the present discussion. Through use of the card processor system, the doctor can determine whether he or she has available samples of the medications to distribute and, if so, can request that a portable consumer transaction payment device be associated with an electronic voucher for a sample of the medication. The request may include a specific number of samples for distribution and a coupon for an OTC item. The request is received by a transaction handler who associates the account identifier of the portable consumer transaction payment device with the drug information.

The doctor may additionally use the card processor system to store information relating to the sample medications, prescribing doctor, patient, prescriptions, dosing instructions, and any other information on the portable consumer transaction payment device. These data could be stored via a magnetic stripe, imbedded microchip, or other memory storage device.

Once done, the patient then presents the portable consumer transaction payment device to a pharmacy to redeem the samples along with an item the patient wishes to purchase. The pharmacy may require the patient to show identification, such as a driver's license, to compare with information printed or stored on the portable consumer transaction payment device. The pharmacy then sends an authorization request for permission to dispense the medication and to charge the pharmaceutical company's account. Additionally, the authorization request may include a request for permission to charge the patient's account associated with the portable consumer transaction payment device for the purchase price of the item. The authorization request is, for example, received by the pharmacy's acquirer who forwards it for processing by a transaction handler.

The transaction handler may then send an authorization response authorizing the distribution of the samples after matching the account identifier of the portable consumer transaction payment device with the associated electronic voucher. The authorization response may further include an authorization response authorizing the purchase of the item after verifying that the patient's account contains sufficient funds to pay for the item. Upon receiving the authorization response, the pharmacy may then distribute the approved quantity of the medication to the patient as well as the item the patient purchased. The transaction handler may also send a request to the issuer of the electronic voucher to debit the pharmaceutical company's account for the cost of the samples and forward that payment to the acquirer for deposit in the pharmacy's account. Furthermore, the transaction handler may send a request to the issuer of the portable consumer transaction payment device to debit the patient's account for the cost of the item purchased and forward that payment to the acquirer for deposit in the pharmacy's account.

The steps, methods, processes, and devices described in connection with the implementations disclosed herein, are made with reference to the Figures, in which like numerals represent the same or similar elements. While described in terms of the best mode, it will be appreciated by those skilled in the art that the description is intended to cover alternatives, modifications, and equivalents as may be included within the spirit and scope of the invention as defined by the appended claims and their equivalents as supported by the following disclosure and drawings. Reference throughout this specification to “one implementation,” “an implementation,” or similar language means that a particular feature, structure, or characteristic described in connection with the implementation is included in at least one implementation of the present invention. Thus, appearances of the phrases “in one implementation,” “in an implementation,” and similar language throughout this specification may, but do not necessarily, all refer to the same implementation.

The described features, structures, or characteristics of the invention may be combined in any suitable manner in one or more implementations. In the following description, numerous specific details are recited to provide a thorough understanding of implementations of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow charts included are generally set forth as logical flow chart diagrams. As such, the depicted order and labeled steps are indicative of one implementation of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising a plurality of steps each being performed by a computing apparatus executing software, wherein the computing apparatus is enabled for network communications, and wherein the steps include:
receiving in a transmission from the network, in response to a request sent over the network, information about a prescription medical supply sample that includes:
an advertising account for a dispensing pharmacist to charge the cost of the prescription medical supply sample for payment to a dispensing pharmacist account to reimburse the dispensing pharmacist for the prescription medical supply sample; and
an identifier, quantity, and dosage of the prescription medical supply sample; and
writing to memory of a portable consumer transaction payment device:
the received information;
an identifier for a patient; and
an identifier for a prescribing medical practitioner prescribing the prescription medical supply sample to the patient, wherein the portable consumer transaction payment device is associated with a patient account for the patient to engage in a plurality of transactions on the patient account with a plurality of merchants in a payment processing network.

2. The method as defined in claim 1, wherein the patient account of the portable consumer transaction payment device and the advertising account are different accounts each of which is a type of account selected from the group consisting of:
an account of regulated limited use for payments to healthcare providers;
a revolving credit account;
a debit account;
a prepaid account;
a Flexible Saving Account (FSA) card account;
a Health Saving Account (HAS) card account;
a Health Reimbursement Account (HRA) card account; and
a combination of the foregoing.

3. The method as defined in claim 1, wherein the writing to the memory further includes writing to the memory an image of a prescription for the patient from the prescribing medical practitioner.

4. The method as defined in claim 3, wherein the image of the prescription comprises respective images corresponding to:
the identifier for the patient;
the identifier for the prescribing medical practitioner of the prescription medical supply sample;
the identifier for the prescription medical supply sample; and
the quantity of the prescription medical supply sample.

5. The method as defined in claim 1, wherein the memory of the portable consumer transaction payment device is selected from the group consisting of:
a non-volatile memory of a semiconductor device;
a magnetic encoded data region of a magnetic stripe; and
a combination of the foregoing.

6. The method as defined in claim 1, wherein the portable consumer transaction payment device is selected from the group consisting of:
a card having a Radio Frequency Identification (RFID) tag, a transponder device and a microchip;
a magstripe card; and
a combination of the foregoing.

7. The method as defined in claim 1, wherein the writing to the memory of the portable consumer transaction payment device is performed by a step selected from the group consisting of:
transmitting data wirelessly to the portable consumer transaction payment device;
transmitting data via a hardwired communication to the portable consumer transaction payment device; and
magnetically encoding track data by modifying the magnetism of magnetic particles on a band of magnetic material on the portable consumer transaction payment device.

8. The method as defined in claim 1, wherein:
the dispensing pharmacist is one said merchant in the payment processing network;
the charging of the cost of the prescription medical supply sample to the advertising account for the payment to the dispensing pharmacist account is another said transaction in the payment processing network; and
each said transaction in the payment processing network is submitted by the merchant to an acquirer for processing by a transaction handler who requests an issuer of a corresponding account upon which the transaction was conducted to obtain payment for the transaction from the corresponding account, and wherein the issuer of the corresponding account forwards the payment for the transaction to the transaction handler who forwards the payment for the transaction to the acquirer to reimburse the merchant for the transaction.

9. The method as defined in claim 1, wherein the network comprises the Internet and the method further comprises, prior to the receiving:
browsing to an Internet website in communication with a web service having a database of information that includes a plurality of different free pharmaceutical samples; and
sending the request to the web service, wherein the request includes a selection of the prescription medical supply sample.

10. The method as defined in claim 1, wherein data written to memory of the portable consumer transaction payment device further comprises an identifier, a quantity, and a dosage of a prescription medical supply, other than the prescription medical supply sample, being prescribed by the prescribing medical practitioner to the patient.

11. A method comprising a plurality of steps each being performed by a computing apparatus by executing software, the computing apparatus being enabled for network communications, wherein the steps include:
receiving a transmission from a network, in response to a request, information about a prescription medical supply sample that includes:
an advertising account for a dispensing pharmacist to charge the cost of the prescription medical supply sample for payment to a dispensing pharmacist account to reimburse the dispensing pharmacist for the prescription medical supply sample; and
an identifier, quantity, and dosage of the prescription medical supply sample; and
writing to memory of a portable consumer health services payment device:
the received information;
an identifier for a patient;
an identifier for a prescribing medical practitioner prescribing the prescription medical supply sample to the patient; and
an identifier, a quantity, and a dosage of a prescription medical supply, other than the prescription medical supply sample, being prescribed by the prescribing medical practitioner to the patient, wherein the patient account is regulated for limited use for payments to the healthcare providers and is for the dispensing pharmacist to charge the cost of the prescription medical supply for payment to the dispensing pharmacist account to reimburse the dispensing pharmacist for the prescription medical supply.

12. The method as defined in claim 11, wherein:
the dispensing pharmacist is one said merchant in the payment processing network;
the charging of the cost of the prescription medical supply sample to the advertising account for the payment to the dispensing pharmacist account is another said transaction in the payment processing network; and
each said transaction in the payment processing network is submitted by the merchant to an acquirer for processing by a transaction handler who requests an issuer of a corresponding account upon which the transaction was conducted to obtain payment for the transaction from the corresponding account, and wherein the issuer of the corresponding account forwards the payment for the transaction to the transaction handler who forwards the payment for the transaction to the acquirer to reimburse the merchant for the transaction.

13. The method as defined in claim 11, wherein the patient account is a type of account selected from the group consisting of:
a Flexible Saving Account card account;
a Health Saving Account card account;
a Health Reimbursement Account card account; and
a combination of the foregoing.

14. The method as defined in claim 11, wherein the writing to the memory further includes writing to the memory an image of a prescription for the patient from the prescribing medical practitioner.

15. The method as defined in claim 14, wherein the image of the prescription comprises respective images corresponding to:
the identifier for the patient;
the identifier for the prescribing medical practitioner of the prescription medical supply sample;
the identifier for the prescription medical supply sample; and
the quantity of the prescription medical supply sample.

16. The method as defined in claim 11, wherein the memory of the portable consumer health services payment device is selected from the group consisting of:
a non-volatile memory of a semiconductor device;
a magnetic encoded data region of a magnetic stripe; and
a combination of the foregoing.

17. The method as defined in claim 11, wherein the portable consumer health services payment device is selected from the group consisting of:
a card having a Radio Frequency Identification (RFID) tag, a transponder device and a microchip;
a magstripe card; and
a combination of the foregoing.

18. The method as defined in claim 11, wherein the writing to the memory of the portable consumer health services payment device is performed by a step selected from the group consisting of:
transmitting data wirelessly to the portable consumer health services payment device;
transmitting data via a hardwired communication to the portable consumer health services payment device; and
magnetically encoding track data by modifying the magnetism of magnetic particles on a band of magnetic material on the portable consumer health services payment device.

19. The method as defined in claim 11, wherein the network comprises the Internet and the method further comprises, prior to the receiving of the transmission:
browsing to an Internet website in communication with a web service having a database of information that includes a plurality of different free pharmaceutical samples; and
sending the request to the web service, wherein the request includes a selection of the prescription medical supply sample.

20. An apparatus comprising:
a user interface to receive a request for a prescription medical supply sample;
a network communication device to:
send the request for the prescription medical supply sample; and
receive an advertising account for a dispensing pharmacist to charge the cost of the prescription medical supply sample for payment to a dispensing pharmacist account to reimburse the dispensing pharmacist for the prescription medical supply sample; and
a card writer to encode prescription data in memory of the portable consumer transaction payment device, wherein:
the prescription data includes:
the advertising account;
an identifier for a patient; and
an identifier for a prescribing medical practitioner;
an identifier, a quantity, and a dosage of:
the prescription medical supply sample; and
a prescription medical supply, other than the prescription medical supply sample, being prescribed by the prescribing medical practitioner to the patient;
and
an image of a prescription for the patient from the prescribing medical practitioner;
the memory of the portable consumer transaction payment device includes a consumer account for a consumer to engage in a plurality of transactions on the consumer account with a plurality of merchants in a payment processing network;
the dispensing pharmacist is one said merchant in the payment processing network;
the charging of the cost of the prescription medical supply sample to the advertising account for the payment to the dispensing pharmacist account is another said transaction in the payment processing network; and
each said transaction in the payment processing network is submitted by the merchant to an acquirer for processing by a transaction handler who requests an issuer of a corresponding account upon which the transaction was conducted to obtain payment for the transaction from the corresponding account, and wherein the issuer of the corresponding account forwards the payment for the transaction to the transaction handler who forwards the payment for the transaction to the acquirer to reimburse the merchant for the transaction.

21. The apparatus as defined in claim 20, further comprising a card reader for reading consumer data encoded in the memory on the portable consumer transaction payment device.
